(19) United States
(12) Patent Application Publication
(10) Pub. No.: US 2005/0070170 A1
(43) Pub. Date: Mar. 31, 2005

(54) Connector contact having wiping function

(76) Inventors: Hongbo Zhang, Kunsan (CN); Yi-Sheng Lin, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/957,170

(22) Filed: Sep. 30, 2004

(30) Foreign Application Priority Data
Sep. 30, 2003 (TW) 92217529

(51) Int. Cl. H01R 13/24

(52) U.S. Cl. 439/700

(57) ABSTRACT

An electrical connector (100) is provided for mating with a terminal (9) of a mating object and includes an insulative housing (21) and a number of conductive contacts (22) held in the housing. Each conductive contact includes a spring portion (223) and a contacting portion (224) forwardly extending from the spring portion. The contacting portion is supported by the spring portion to be elastically movable in a first direction and a second direction. A contacting point (2240) downwardly bends and extends from a front section of the contacting portion to be brought into mate with a mating object (9).

### BACKGROUND OF THE INVENTION

1. Field of the Invention

This invention relates to an electrical connector and in particular, to an electrical connector having a wiping function.

2. Description of the Prior Art

Spring contacts for electrical interfaces are well known in the prior art and represent a wide family of technology for providing interconnection between electrical contact elements. A known type of such a conventional connector is disclosed in U.S. Pat. No. 6,524,140 B2 issued to Takagi et al. on Feb. 25, 2003. The Takagi connector comprises an insulator and a plurality of conductive contacts received in the insulator. Each contact includes a contacting arm having a contact point extending beyond a mating opening of the insulator, and a spring portion integrally formed with the contacting arm. The insulator has a stopper portion adjacent to the mating opening thereof for elastically pressing a lower portion of the spring portion inwardly, thereby maintaining the contacting arm in a normal downwardly inclined state. When the connector mates with a complementary connector, the contacting arm of each contact is depressed inwardly and is free from the pressing of the stopper portion of the insulator, thereby moving upwardly relative to the complementary connector. As a result, the contacting arm upwardly goes back to a horizontal state.

However, being always pressed by the stopper portion of the housing, the spring portions of the contacts of the Takagi connector may be distorted or become robustless after repeatedly mating with the complementary connector, thus the contacts can not electrically and reliably connect with mating contacts of the complementary connector. Moreover, it is desired that the contacting portions be clean and having a low contact resistance. The Takagi contacts move from the inclined position to the horizontal position to provide the so-called “wiping effect”. Due to elastic distortion of the Takagi contacts, a distance between inclined position and the horizontal position will be decreased, thus rendering unsatisfied wiping effects.

### BRIEF SUMMARY OF THE INVENTION

It is an object of the present invention to provide an electrical connector which has a reliability contacting and a simple structure and can be easily manufactured.

In order to attain the object above, an electrical connector is provided for mating with a mating object and includes an insulative housing and a number of conductive contacts held in the housing. Each conductive contact includes a spring portion and a contacting portion forwardly extending from the spring portion. The contacting portion is supported by the spring portion to be elastically movable in a first direction and a second direction. A contacting point downwardly bends and extends from a front section of the contacting portion to be brought into mate with a mating object.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector according to the present invention;

FIG. 2 is a partially exploded view of the electrical connector;

FIG. 3 is a partially perspective view of the electrical connector;

FIG. 4 is a partially sectional enlarged view of a contacting portion according to a first embodiment of the invention at the start of connection with a mating object;

FIG. 5 is a partially sectional enlarged view of a contacting portion according to the first embodiment of the invention at the completion of connection with the mating object;

FIG. 6 is a partially sectional enlarged view of a contacting portion of a second embodiment of the invention at the start of connection with the mating object; and

FIG. 7 is a partially sectional enlarged view of a contacting portion of the second embodiment of the invention at the completion of connection with the mating object.

### DETAILED DESCRIPTION OF THE INVENTION

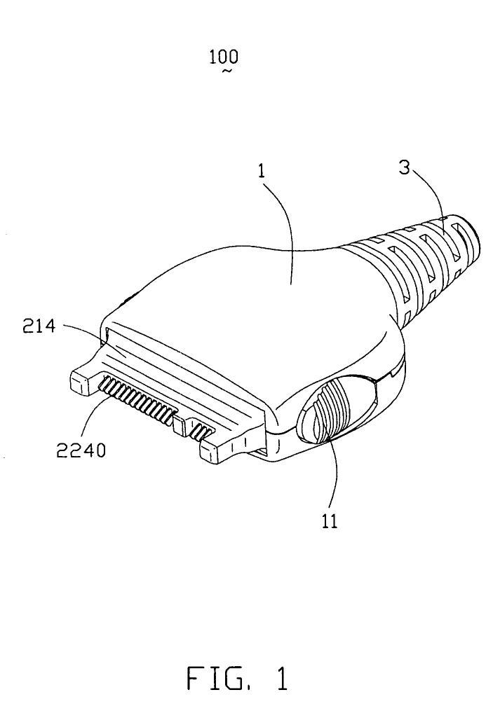

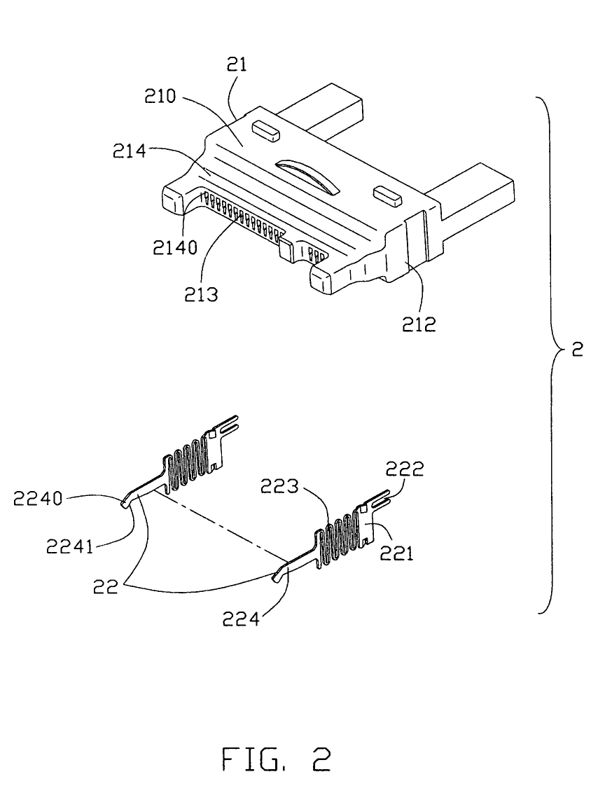

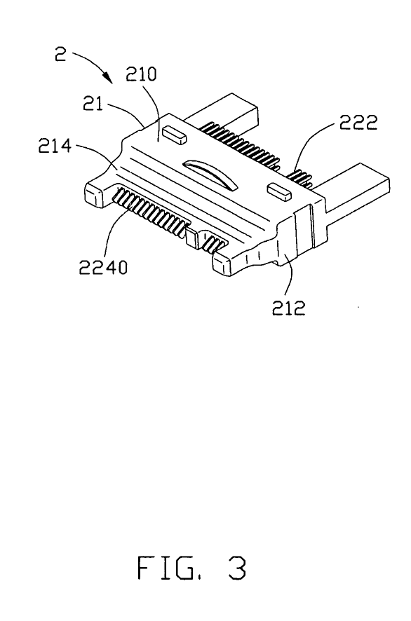

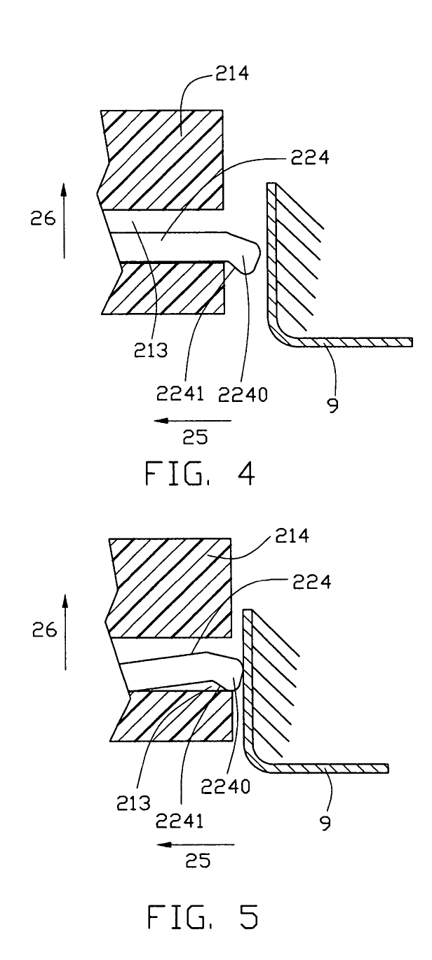

Referring to FIGS. 1-2, an electrical connector 100 in accordance with a first embodiment of the present invention comprises a cover 1 with a button 11, a contact module 2 and a connecting portion 3 positioned in a rear section of the cover 1 for connecting cables.

Referring to FIG. 2, the contact module 2 comprises a generally U-shaped insulative housing 21 and a plurality of conductive contacts 22 fixed in the housing 21. The insulative housing 21 includes an upper wall 210, a lower wall 211, a pair of opposite side walls 212 and a plurality of receiving grooves 213 extending in a front-to-rear direction for accommodating the contacts 22. The housing 21 further includes a mating portion 214 positioned on a front section thereof for mating with a terminal 9 of a mating object (not shown), shown in FIGS. 4-7.

The conductive contacts 22 extend in the front-to-rear direction and vertically stand in the receiving grooves 213. Each conductive contact 22 comprises a fixing portion 221 fixed in the insulative housing 21, a soldering portion 222 extending rearward from a rear section of the fixing portion 221 for soldering to a printed circuit board (not shown), a spring portion 223 extending forwardly from a front section of the fixing portion 221 and a contacting portion 224 extending forwardly from a front end of the spring portion 223 for mating with the terminal 9 of the mating object. The contacting portion 224 includes a horizontal portion (not labeled) extending forwardly from a front end of the spring portion 223 and a contacting point 2240. The contacting point 2240 forwardly and downwardly extends from the horizontal portion, thereby forming a lower inclined edge 2241. The horizontal portion lies in a bottom portion of the receiving groove 213. The contacting point 2240 normally projects forwardly beyond the mating portion 214 and is bent downwardly from the horizontal portion at a predetermined angle. The angle is preferably smaller than 45 degrees and greater than 0 degree.

Referring to FIGS. 4-5, in use, being pushed by a mating surface of the terminal 9 of the mating object in the first direction 25, the contacting portion 224 is rearward pushed into the receiving groove 213 and further rearward urges the spring portion 223. At the same time, the lower inclined edge 2241 slides along the bottom portion of an opening of the receiving groove 213. As a result, the contacting point 2240 interferential slides upwardly on the mating surface of the terminal 9 of the mating object in a second direction 26 perpendicular to the first direction 25. During the upwardly sliding movement of the contacting point 2240 on the terminal 9 of the mating object, the contacting point 2240 scratches the mating surface of the terminal 9 of the mating object and cleans oxide or dust formed at the mating surface of the terminal 9 of the mating object, thereby obtaining a reliable electrical connection between the contacting point 2240 and the terminal 9 of the mating object.

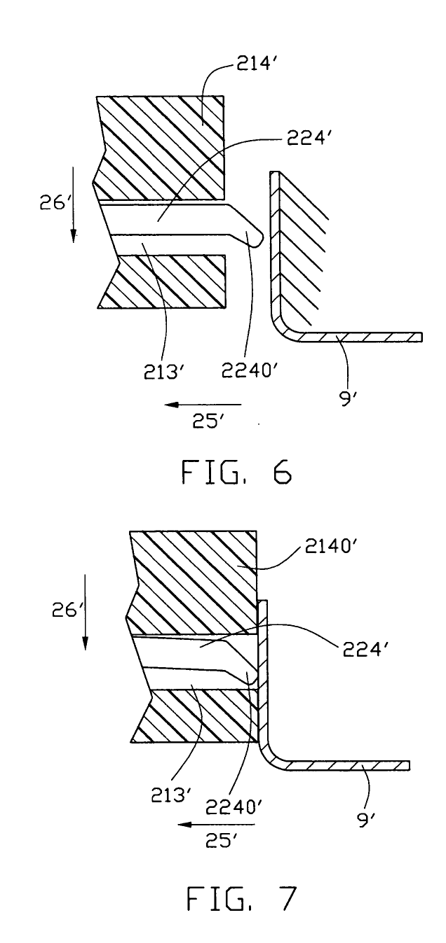

Referring to FIGS. 6-7, an electrical connector 100′ according to a second embodiment of the present invention has a contacting portion 224′. The contacting portion 224′ lies in a top portion of the receiving groove 213′. The contacting portion 224′ comprises a contacting point 2240′ bent downwardly from a horizontal portion thereof at an angle greater than 45 degrees. In the second embodiment, other elements of the electrical connector 100′ have constructions similar to those of the first embodiment, thus, a detail description thereof is omitted herefrom.

As with the first embodiment, approaching force is applied between the electrical connector 100 and the terminal 9′ of the mating object, the contacting portion 224′ is pushed into the receiving groove 213′, urging the spring portion 223 in the first direction 25′ in a first direction 25′. With the angle of the contacting portion 223 is greater than 45 degrees, the contacting portion 223 is approached a downward force, therefore the contacting point 2240′ wipes on the terminal 9′ of the mating object in a second direction 26′ perpendicular to the first direction 25′. Therefore, the wiping function is achieved.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. An electrical connector adapted for mating with a mating object comprising:
an insulative housing defining a receiving groove; and
a conductive contact comprising a fixing portion fixed in the receiving groove, a spring portion extending from the fixing portion and a contacting portion extending from the spring portion for electrically connecting with the mating object, the contacting portion having a bent contacting point.

2. The electrical connector according to claim 1, wherein the contacting portion of the conductive contact comprises a horizontal portion forwardly extending from the spring portion and is received in the receiving groove, the contacting point extending from the horizontal portion and projecting beyond the housing.

3. The electrical connector according to claim 2, wherein the horizontal portion is straight and is parallel to the receiving groove.

4. The electrical connector according to claim 2, wherein the horizontal portion of the conductive contact lies in a lower portion of the receiving groove.

5. The electrical connector according to claim 1, wherein the contacting point has a predetermined angle, and wherein the predetermined angle is smaller than 45 degrees.

6. The electrical connector according to claim 2, wherein the horizontal portion of the conductive contact lies in an upper portion of the receiving groove.

7. The electrical connector according to claim 1, wherein the contacting point has a predetermined angle, and wherein the predetermined angle is larger than 45 degrees.

8. An electrical connector adapted for mating with a mating object comprising:
an insulative housing defining a receiving groove; and
a conductive contact comprising a fixing portion fixed in the receiving groove, a spring portion extending from the fixing portion and a contacting portion extending from the spring portion and out of a mating face of the housing for electrically connecting with the mating object, the contacting portion defining at a tip thereof a non-linear contacting point resulting in both linear movement in a direction parallel to the mating face and in another direction along said receiving groove.

9. An electrical connector adapted for mating with a mating object comprising:
an insulative housing defining a receiving groove; and
a conductive contact comprising a fixing portion fixed in the receiving groove, a spring portion extending from the fixing portion and a contacting portion extending from the spring portion and out of a mating face of the housing for electrically connecting with the mating object, the contacting portion defining at a tip thereof a non-linear contacting point which is directly engaged by the mating face to result in a curved movement when a mating object is mated therewith.
